(19) United States
(12) Patent Application Publication
(10) Pub. No.: US 2007/0240030 A1
(43) Pub. Date: Oct. 11, 2007

(54) Interactive podcast

(75) Inventor: David Cronstrom, Malmo (SE)

Correspondence Address: ALBIHNS STOCKHOLM AB, BOX 5581, LINNEGATAN 2, SE-114 85 STOCKHOLM; SWEDENn, STOCKHOLM, SE

(73) Assignee: Sony Ericsson Mobile Communications AB, Lund (SE)

(21) Appl. No.: 11/419,203

(22) Filed: May 19, 2006

Related U.S. Application Data
(60) Provisional application No. 60/744,416, filed on Apr. 7, 2006.

(51) Int. Cl. G06F 17/00

(52) U.S. Cl. 715/500.1

(57) ABSTRACT

A method for providing updateable content to a mobile device, in which links are included in a podcast with media data such as audio or video, to create an interactive podcast service for mobile communication devices. The method comprises the steps of: creating updateable content and formatting the content into a media format; providing a selectable link to additional content associated with the created updateable content; storing the created updateable content on a server; creating an indicator that describes the updateable content and the address of said server that stores the updateable content; subscribing to the updateable content using the mobile device by selecting the indicator and thereby registering to the updateable content; checking from the mobile device the indicator if content has been updated; and retrieving the created content with the selectable link to the mobile device when the content has been updated.

### FIELD OF THE INVENTION

The invention relates to a method for providing podcasts to a mobile device and especially providing interactive podcasts to a user of a mobile device.

### BACKGROUND TO THE INVENTION

Podcasts have had a phenomenal success. Content is being produced, subscribed to and downloaded everyday. Subscribing to a podcast makes the user able to download content for listening or viewing online or offline. Initially Podcasts were limited to audio files but recently also video files are being used for downloading, known as Vodcast or Vidcast (video on demand broadcastings). Both podcasts and Vodcasts mainly use RSS (Really Simple Syndication) or Atom syndication to distribute the content over the Internet. Podcasting is an automatic mechanism by which multimedia computer files are transferred from a server to a client which pulls down XML files containing the Internet addresses of the media files. A podcast is typically downloaded to an Apple®Ipod or a similar portable media player. However, podcasts will be expanded to include mobile phones as well. This will change the features of the podcast due to the limitation that exists today, since the Ipods and media players only can subscribe/download files. Due to the fact that portable media players do not have any means for communications the different devices can not interact with the content in any way. However, with mobile phones, PDA with GSM-radios or Laptops with WiFi or the like the possibilities of making sessions interactive are open wide.

Windows media enhanced podcast provides a method for incorporating links into a podcast. However, these links are arranged to be implemented in a podcast and to automatically open up sites in a browser without the user making an active selection. Also the podcast is meant to be viewed from a stationary computer with a full sized display.

The object of the invention is to provide Interactive podcasts for a user using a mobile device, which would open up possibilities for advertising and other interactive services, such as voting, chatting, emailing, and the like. This would increase the usage of podcasts over the net.

### SUMMARY OF THE INVENTION

The present invention relates to a method for providing updateable content to a mobile device comprising the steps of; creating updateable content and formatting the content into a media format; providing a selectable link to additional content associated with the created updateable content; storing the created updateable content on a server; creating an indicator that describes the updateable content and the address of said server that stores the updateable content; subscribing to the updateable content using the mobile device by selecting the indicator and thereby registering to the updateable content; checking from the mobile device the indicator if content has been updated; and retrieving the created content with the selectable link to the mobile device when the content has been updated.

In one embodiment of the present invention the selectable link is provided to the content when the content is formatted.

In one embodiment of the present invention the content is embedded in a web site. In one embodiment of the present invention the selectable link is provided to said web site.

In one embodiment of the present invention the content is embedded in a media player. In one embodiment of the present invention the link is provided to the media player.

In one embodiment of the present invention the content is a podcast. In an alternative embodiment of the present invention the content is a vidcast.

In one embodiment of the present invention the additional content is a web site. In one embodiment of the present invention the additional content is a voting registry.

Since mobile phones and the like have communication possibilities interactive podcasts will be possible. The interactive podcasts differ from traditional podscasts in the manner of being able to contain, e.g. weblinks or the similar that are embedded in the content or put on top of it. The links may be linking the user to an advertiser's website making the user able to buy something related to the content, a TV producer's website to get more information about the show and the like. An Interactive Podcast could also be solved by downloading a complete webpage or media player with the video or audio file embedded in the page rather than downloading the mp3-file. If it is solved in this way weblinks can be included and sold to potential advertisers, button on the media players could be sold to advertisers to attract users to their offerings.

### BRIEF DESCRIPTION OF THE DRAWINGS

In the following, the invention will be explained by means of a description of embodiments with reference to the appended drawings, wherein;

FIG. 1 is a schematic view of a system wherein an embodiment of the invention is used;

FIG. 2 illustrates an embodiment of the present invention;

FIG. 3 shows a block diagram over a related art method of retrieving a podcast; and

FIG. 4 shows a block diagram of alternative embodiments of the invention.

### DETAILED DESCRIPTION OF EMBODIMENTS OF THE INVENTION

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The present invention is described below with reference to block diagrams and/or flowchart illustrations of methods, apparatus (systems) and/or computer program products according to embodiments of the invention. It is understood that several blocks of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described herein as employed in and with a wireless communications device, also denoted a mobile device. In the context of the invention, the mobile device may e.g. be a mobile phone, a PDA (Personal Digital Assistant), a portable media players such as e.g. a future iPod with a radio transmitter/receiver or any other type of portable computer such as laptop computer.

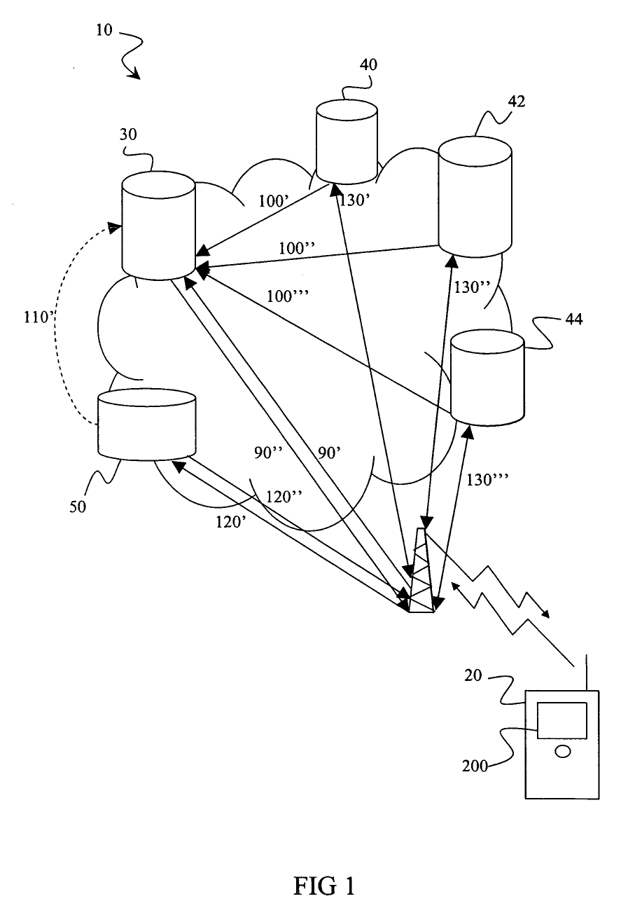

Referring to FIG. 1, a system for podcasting content from content servers 40, 42, 44 to a mobile communications device 20 is generally indicated at 10. The mobile device 20, such as a mobile phone, is registered at a podcast portal server 30. The registering 90′ may be done in advance over the Internet or in real time by using the mobile device 20 to select content to subscribe to at the podcast portal server 30. The podcast portal server receives RSS feeds from other servers 40, 44, other users 42 or the like. An RSS feed is a machine-readable list of the URIs, Uniform Resource Identifiers, by which podcasts may be accessed. The RSS feed is transferred 100′, 100″, 100″′ to the podcast portal server 30. The content of the servers 40-44 is preferably in a media format such as mp3 format for audio and MPEG-4 for video or the likes. When the user has decided to subscribe to certain podcasts through the podcast portal server 30, the RSS feeds related to these podcasts are transferred to the mobile device 20. The RSS feed is then used at the mobile device 20 by an aggregator that continuously checks the status of the subscribed feeds to see in the feed has changed. When the feed has changed the mobile device retrieves the content from the server 40-44. The user can then browse the content at leisure. The content is further provided with links to additional content such as websites, polls, chat rooms, an email-address, phone number, or the like. In an embodiment the web links may be incorporated by the source 40, 42, 44 of the content by incorporating web links on top of media format used or embedding links into the content. In the illustrated embodiment the selected RSS feed is sent 90″ from the podcast portal server 30 to the mobile device 20, and if the RSS feed indicates that content of the subscribed podcast has been updated, the updated content is retrieved 130′, 130″, 130″′ directly from the content server 40-44 to be viewed, listened to or stored in the mobile device 20.

Embedded in the content is a selectable link which directs the mobile device to additional content. Such additional content may e.g. be an Internet shop web site of an advertiser. The link directs the user to the web site when the user interacts with a link, i.e. selects the link. In one embodiment of the invention, the podcast content is provided to the user by means of a complete webpage or media player, with the video or audio embedded in the page or the player, which webpage or media player is downloaded from content servers.

In another embodiment, the player or webpage may as such be supplied by the podcast portal server 30, whereas the content to be provided to the user through the webpage or player, is downloaded from the content servers 40-44. In such an embodiment the providing of links may be done in the podcast portal server 30. In this embodiment the links may be incorporated as regular web links, links configured as media player buttons, or the like. In the illustrated embodiment the link takes the user 120′ to a Internet shop site 50 of an advertiser, since the advertiser has bought or licensed 110′ a link that should be incorporated in the content in the podcast portal server 30. When the user selects the link the web site is retrieved 120″ and opened as a new window on top of the playing media. It should be understood that the media file may be paused; alternatively the web site will replace the podcast window. By enhancing the podcasts with interactive links the possible area of commerce increases tremendously and lots of possible services to users may be implemented. It should be understood, though, that the links may be implemented in the content when encoding the content prior to storing the content in servers 40-44 as well as through a separate process.

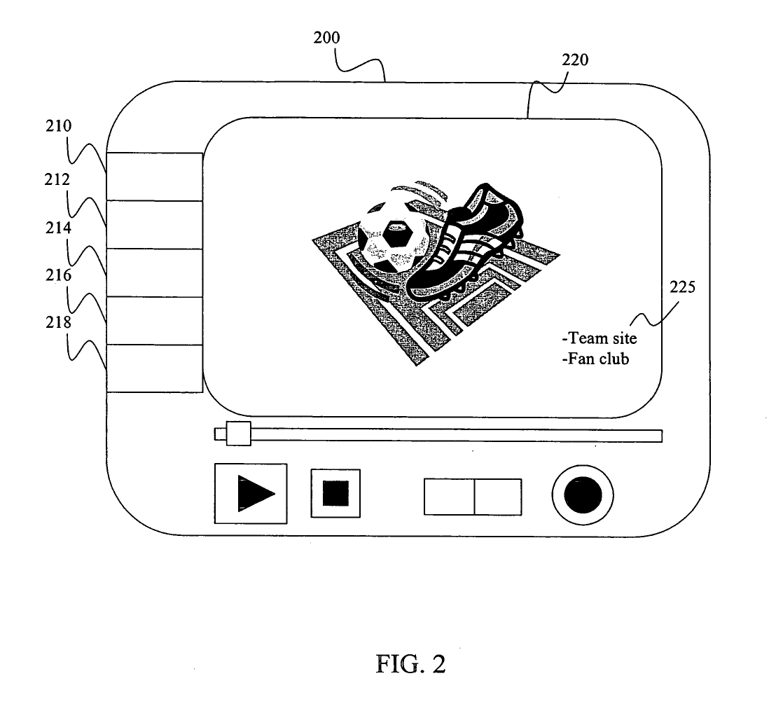

Now referring to FIG. 2, a display screen 200 of a mobile device is shown. In the illustrated embodiment the podcast including data of video, a so called vidcast, is embedded in a player which is transferred to the mobile device 20 when the mobile device 20 has registered to the podcast service. The podcast is displayed to the user in an area 220. In the podcast links 225 have been embedded and are selectable by the user in order to browse to a certain site or area. The selection of links is preformed by the user of the mobile device 20 by using e.g. a navigation tool such as a joystick, projecting buttons, touch screen or the like. It should be understood that the display area 220 could be omitted or only show selectable links if the podcast only contains audio material. In the illustrated embodiment of FIG. 2 the podcast player is provided with a number of link buttons 210-218. The link buttons are configured to include links to different sites, these sites may be merchandise sites, topic sites, personal sites or the like. This enables the user of the mobile device to interactively select links to different content. As an example, the link 216 is a chatting button which, when selected, takes the user to a chat room that is downloaded to the mobile device 20. The buttons 212-214 may be voting buttons for recommending the podcast to other users, such as yes/no buttons or the like. The links may also be an email-address, phone number, or similar

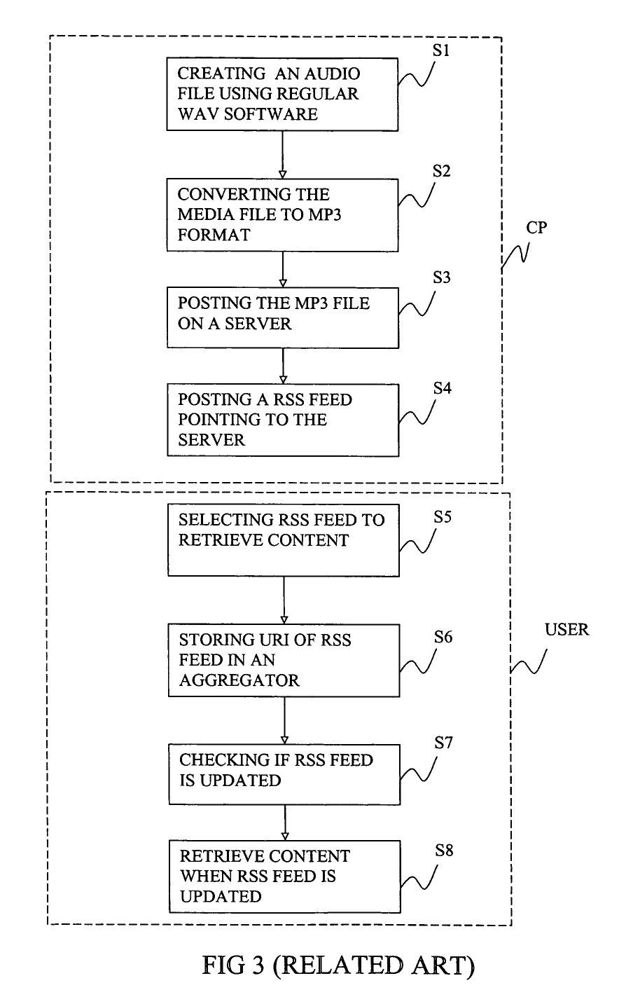

The process of a podcast will now be explained schematically referring to FIG. 3. For servers and other functional elements used in the process, reference is also made to FIG. 1, for the sake of simplicity and clarity. In Step S1, the content is created, such as audio content or the like, and recorded as a WAV file, in the case of audio. The content is converted into an mp3 format in order to reach as many listeners as possible and to compress size of the file, as stated in S2. In step S3, the mp3 file is posted on a server 40-44 on the Web in order to let listeners access the content. In order to allow listeners to subscribe to the content an RSS feed needs to be created. An RSS feed is an XML file that describes the content. The key piece of RSS that makes podcasting possible is the enclosure tag, which lets an aggregator automatically download a new file. In step S4, the RSS feed is posted on a web server 30 acting as a portal for podcasts. Steps S1-S4 are typically performed by the content provider, CP. Now to further explain the process of podcasting, steps S5-S8 concerning the listener of the podcast is explained. In step S5, a user visiting the podcast portal server 30 or the like selects a podcast to subscribe to. The device 20 of the user contains an aggregator that stores the address information concerning the RSS feed, as stated in step S6. The aggregator is computer program which is downloaded upon subscription to a podcast service, if not already present in the device 20. In step S7, the aggregator continuously checks if the RSS feed has been updated. This may be done every hour, once a week or the like. When the RSS feed has been updated the content is retrieved to the device 20, as stated in S8.

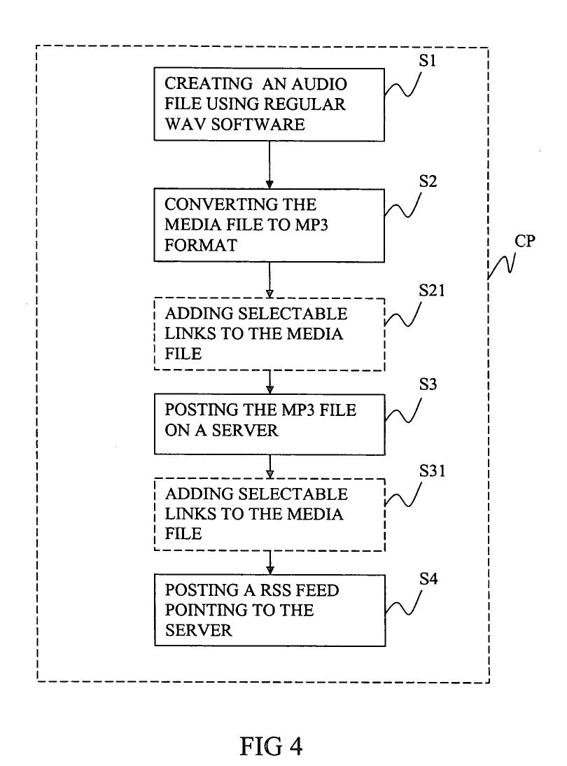

It should be understood that the links according to the present invention are added either during the encoding of the content or in a separate process, wherein the links may be embedded in buttons of a media player or a web site. FIG. 4 shows alternative embodiments of providing links as boxes with broken lines. In step S21 the links are provided in the content during the encoding of the content and may be implemented as clickable text links embedded in the content and subsequently stored in servers 40-44. However, links may alternatively or additionally be provided after the encoding by the content provider in a separate process wherein the content provider provides text links on top of the content. In alternative embodiments of the invention, as stated in step S31, the links are provided at a server 40-44 that stores the content. In these embodiments the content may be embedded in a webpage or a player in the server 40-44 that stores the content, and the links are provided either to be activated by means of buttons of the player or the webpage, or as text links on top of the content. It should be understood that the webpage and/or the media player may be received with the podcast embedded in it as one unit, i.e. the podcast is stored as an html file with a audio/video file, or as separate units wherein the page or the player is received from portal server 30 and the podcast is received from a content server. In this type of embodiment the providing of links may be done in the server acting as a portal for podcasts. The portal server 30 provides the media player or the html page to the mobile device with embedded selectable links while the podcast is received from a different server.

The foregoing has described the principles, preferred embodiments and modes of operation of the present invention. However, the invention should be regarded as illustrative rather than restrictive, and not as being limited to the particular embodiments discussed above. It should therefore be appreciated that variations may be mad in those embodiments by those skilled in the art without departing from the scope of the present invention as defined by the following claims.

I claim:

1. A method for providing updateable content to a mobile device comprising the steps of:
creating updateable content into a media format;
providing a selectable link to additional content associated with the created updateable content;
storing the created updateable content on a server;
creating an indicator that describes the updateable content and the address of said server that stores the updateable content;
subscribing to the updateable content using the mobile device by selecting the indicator and thereby registering to the updateable content;
checking the indicator to determine if content has been updated; and
retrieving the created content with the selectable link to the mobile device when the content has been updated.

2. A method according to claim 1, wherein the selectable link is provided to the content when the content is formatted.

3. A method according to claim 1, wherein the selectable link is provided to the content after the content has been formatted, in a content server.

4. A method according to claim 1, wherein the content is embedded in a web site.

5. A method according to claim 4, wherein the selectable link is provided to said web site.

6. A method according to claim 1, wherein the content is embedded in a media player.

7. A method according to claim 6, wherein the link is provided to the media player.

8. A method according to claim 1, wherein the content is a podcast.

9. A method according to claim 1, wherein the content is a vidcast.

10. A method according to claim 1, wherein the additional content is a web site.

11. A method according to claim 1, wherein the additional content is a voting registry.
